(19) United States
(12) Patent Application Publication
(10) Pub. No.: US 2008/0100915 A1
(43) Pub. Date: May 1, 2008

(54) Removal of oxidation layer from metal substrate and deposition of titanium adhesion layer on metal substrate

(76) Inventors: Kuohua Wu, Tucson, AZ (US); Andrew L. Van Brocklin, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/553,963

(22) Filed: Oct. 27, 2006

(51) Int. Cl. G02B 5/28

(52) U.S. Cl. 359/589

(57) ABSTRACT

An oxidation layer is removed from a metal substrate by plasma etching. A titanium adhesion layer is deposited on the metal substrate. A multiple-layer dielectric is deposited on the titanium adhesion layer. The titanium adhesion layer improves adhesion of the multiple-layer dielectric to the metal substrate.

### BACKGROUND

Projectors are devices employed to project image data for viewing by relatively large numbers of viewers, and may be used as computing device peripherals, as well as displays for home theaters and other applications. To obtain optimal projection of the image data, projectors include projector lamp assemblies that are capable of outputting bright light. One way to improve the usefulness and projection quality of projectors is to increase the light output by their projector lamp assemblies, so that the projectors can be utilized even in environments in which there is ambient light.

Increasing projector lamp assembly light output can be achieved at least by using more powerful and/or brighter lamps within the assemblies, or by better utilizing the light output by existing lamps within the assemblies. In the latter approach, for instance, at least some of the light output by lamps within projector lamp assemblies may not be properly directed outwards from the projectors to project image data. Rather, the light may be transmitted, absorbed, and/or reflected within the projectors in a way that the light is not used to project image data.

### BRIEF DESCRIPTION OF THE DRAWINGS

FIGS. 1A and 1B are diagrams depicting representative projector lamp assemblies, according to varying embodiments of the invention.

FIG. 2 is a cross-sectional diagram of a reflector for a projector lamp assembly, according to an embodiment of the invention.

FIG. 3 is a flowchart of a method for at least partially fabricating a reflector for a projector lamp assembly, according to an embodiment of the invention.

FIGS. 4A, 4B, 4C, 4D, 4E, 4F, and 4G are diagrams illustratively exemplary performance of various parts of the method of FIG. 3, according to an embodiment of the invention.

### DETAILED DESCRIPTION

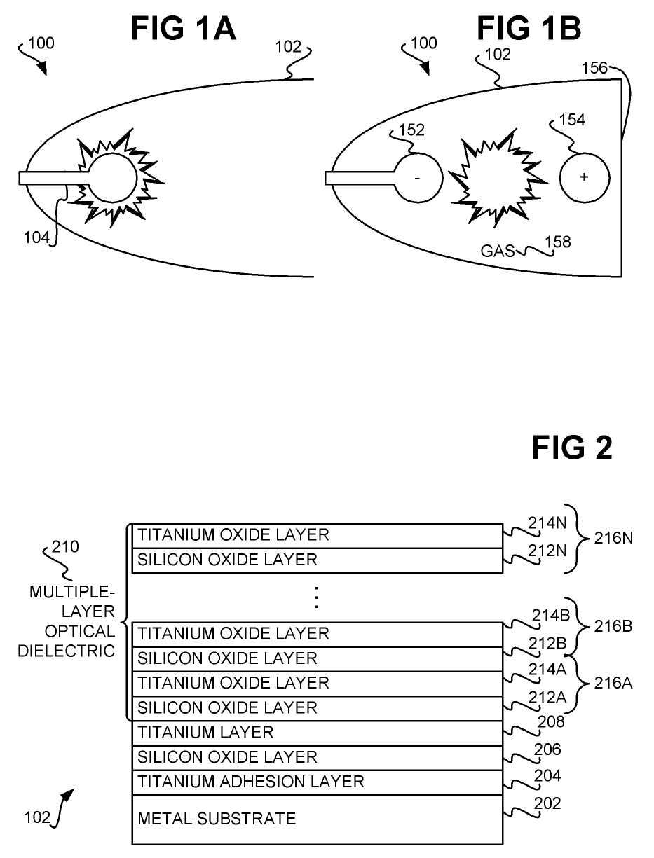

FIGS. 1A and 1B show a representative projector lamp assembly 100, according to two different embodiments of the invention. The projector lamp assembly 100 can include components in addition to and/or in lieu of those shown in FIGS. 1A and 1B. That is, other types of projector lamp assemblies may also be utilized in relation to embodiments of the invention. The projector lamp assembly 100 includes a metal reflector 102. The metal reflector 102 may be or include copper (Cu), aluminum (Al), or another type of metal. The metal reflector 102 is desirably shaped to reflect light outwards from the projector lamp assembly 100. For instance, the metal reflector 102 may be at least partially elliptically shaped in this respect.

FIG. 1A specifically shows an enclosed bulb-type projector lamp assembly 100, such as one that utilizes a mercury (Hg) gas lamp. An enclosed lamp 104 is situated within the metal reflector 102. The enclosed lamp 104 may be a mercury gas lamp, or another type of enclosed lamp. The lamp 104 is enclosed in that its gas is completely enclosed within the lamp 104 itself, such that light is generated within the lamp 104 and projected outwards from the lamp 104.

FIG. 1B specifically shows a high-intensity discharge (HID)-type projector lamp assembly 100, such as one that utilizes xenon (Xe) gas. Situated within the metal reflector 102 are an anode 152 and a cathode 154. The interior of the reflector 102 houses gas 158, such as xenon gas, and the reflector 102 is capped by a cap 156 to prevent the gas 158 from escaping. Excitation of the anode 152 results in HID of the gas 158, which results in the generation of light. Because the light is not generated within an enclosed or sealed lamp situated within the reflector 102, the assembly 100 is not an enclosed bulb-type assembly. Rather, due to the generation of light resulting from HID of the gas 158, the assembly 100 is a HID-type assembly.

Some embodiments of the invention are concerned with improving the metal reflector 102. The reflectivity of the reflector 102 is improved so that as much of the light generated within the projector lamp assembly 100 is used for image data projection. Furthermore, the reflector 102 is fabricated so that it substantially reflects just visible light energy of the light generated within the projector lamp assembly 100. That is, other types of light energy, such as infrared energy and ultraviolet energy, are absorbed by the reflector 102. This is desirable, because infrared energy reflected to other components of a projector can undesirably heat those components, and ultraviolet energy reflected to other components of the projector can cause the components to malfunction.

FIG. 2 shows the metal reflector 102 in cross-sectional detail, according to an embodiment of the invention. The reflector 102 is shown in FIG. 2 as being flat for illustrative clarity and convenience, whereas in actuality the reflector 102 may be formed to a particular shape, as in FIGS. 1A and 1B. The thicknesses of the various layers of the reflector 102 are exaggerated in size in FIG. 2 for illustrative clarity, and further are not drawn to scale in FIG. 2 for illustrative convenience. Finally, the reflector 102 may include other layers, in addition to and/or in lieu of those specifically depicted in FIG. 2.

The metal reflector 102 is metal in that it includes a metal substrate 202. The metal substrate 202 may be copper, aluminum, or another type of metal. The metal substrate 202 may be polished, such as by using a diamond-turning polishing, to ensure that the substrate 202 has the highest reflectivity (i.e., the smoothest surface) possible to reflect the most light as is possible. During atmospheric exposure, such as during or after the polishing process, an undesired oxide layer may grow on the metal substrate 202. This undesired oxide layer is removed, such as by plasma etching, prior to the deposition of any further layers on the metal substrate 202, because the undesired oxide layer can reduce the performance of the multiple-layer dielectric coating that is subsequently deposited on to the surface of the reflector 102. This performance decrease is caused by the difference in the index of the undesired layer versus the index of the metal layer for which the dielectric coating is designed. Furthermore, the undesired oxide layer, which may have a thickness between 2 and 25 nanometers (nm), can result in poor adhesion between a multiple-layer dielectric coating and the substrate 202, because this oxide layer is soft and rough.

A titanium (Ti) adhesion layer 204 is deposited on the metal substrate 202. The titanium adhesion layer 204 promotes adhesion of a subsequently deposited multiple-layer optical dielectric 210 to the metal substrate 202. Were the multiple-layer optical dielectric 210 deposited directly on the metal substrate 202, high thermal stress between the substrate 202 and the dielectric 210 can result in poor adhesion of the dielectric 210 on the substrate 202, such that cracking and peeling of the dielectric 210 can occur.

In one embodiment, a silicon oxide (SiO₂) layer 206 and another titanium layer 208 are deposited on the metal substrate 202—specifically on the titanium adhesion layer 204—prior to deposition of the multiple-layer optical dielectric 210. The silicon oxide layer 206 is at least substantially transparent to visible light, and is present so that two discrete titanium layers, the titanium adhesion layer 204 and the other titanium layer 208, can be present on the metal substrate 202. The titanium layers 204 and 208 are tuned to absorb as much infrared energy as possible, by experimental determination of the thicknesses of both layers 204 and 208 that result in maximum infrared energy absorption.

That is, light generated within the projector light assembly 100 is transmitted through the multiple-layer optical dielectric 210, reflected by the metal substrate 202, and transmitted back through the optical dielectric 210. Tuning the titanium layers 204 and 208 to absorb as much infrared energy as possible reduces the amount of infrared energy of the light that is reflected by the substrate 202 and transmitted back through the optical dielectric 210. This is advantageous, ensuring that undue heating of other projector components does not occur. The titanium layers 204 and 208 can absorb as much as 80%, or more, of the infrared energy in one embodiment.

The multiple-layer optical dielectric 210 includes one or more dual silicon oxide-titanium oxide (TiO₂) layers 216A, 216B, . . . , 216N, collectively referred to as the dual silicon oxide-titanium oxide layers 216. The dual layers 216 include silicon oxide layers 212A, 212B, . . . , 212N, collectively referred to as the silicon oxide layers 212, and titanium oxide layers 214A, 214B, . . . , 214N, collectively referred to as the titanium oxide layers 214. The silicon oxide layers 212 and the titanium oxide layers 214 are interleaved in relation to one another as is shown in FIG. 2. Each of the dual layers 216 thus includes a deposited silicon oxide layer, and a titanium oxide layer deposited on the silicon oxide layer of the dual layer in question.

The multiple-layer optical dielectric 210 is deposited on the metal substrate 202, specifically on the other titanium layer 208, also so that at least substantially just visible light energy of light generated within the projector assembly 100 is reflected by the metal substrate 202. The silicon oxide layers 212 are substantially transparent to visible light. The titanium oxide layers 214, by comparison, substantially absorb ultraviolet energy (and may also absorb some infrared energy). The silicon oxide layers 212 are present so that a number of discrete titanium oxide layers 214 can be present. The titanium oxide layers 214 are tuned to absorb as much ultraviolet energy as possible, by experimental determination of the thicknesses and the number of the layers 214 that result in maximum ultraviolet energy absorption.

That is, light generated within the projector light assembly 100 is transmitted through the multiple-layer optical dielectric 210, and the visible light thereof is reflected by the dielectric 210 before it reaches the titanium layer 208. The dielectric 210 is tuned to absorb as much ultraviolet energy as possible, by experimentally determining the thickness thereof that achieves this. (Likewise, the infrared energy transmitted through the dielectric 210 is absorbed by the titanium layers 204 and 208, where these layers have been tuned appropriately by experimental determining the thicknesses thereof that achieves this.) This is advantageous, ensuring that ultraviolet energy-sensitive projector components are not exposed to undue ultraviolet energy that may result in their malfunctioning. In one embodiment, there are 22 dual layers 216, each including a silicon oxide layer and a titanium oxide layer. As such, in this embodiment there are 47 total layers deposited on the metal substrate 202, including the dual layers 216 of the multiple-layer dielectric 210 and the layers 204, 206, and 208.

The following table depicts the actual number and thickness of the layers deposited on the metal substrate in one embodiment of the invention. The first column denotes the layer number, where the lowest layer number of 1 denotes the top-most layer 214N in FIG. 2, and the highest layer number of 47 denotes the bottom-most layer 204 in FIG. 2. The second column denotes the composition of a layer, such as titanium oxide, silicon oxide, or titanium. The third column denotes the thickness of a layer in nanometers (nm). The total thickness indicated in the table is the thickness of all the layers deposited on the metal substrate 202, and does not include the thickness of the substrate 202 itself, which can vary.

| | | |
|---|---|---|
| 1 | Titanium oxide | 47.1 |
| 2 | Silicon oxide | 99.92 |
| 3 | Titanium oxide | 44.27 |
| 4 | Silicon oxide | 80.58 |
| 5 | Titanium oxide | 47.1 |
| 6 | Silicon oxide | 80.58 |
| 7 | Titanium oxide | 47.1 |
| 8 | Silicon oxide | 80.58 |
| 9 | Titanium oxide | 47.1 |
| 10 | Silicon oxide | 80.58 |
| 11 | Titanium oxide | 47.1 |
| 12 | Silicon oxide | 80.58 |
| 13 | Titanium oxide | 47.1 |
| 14 | Silicon oxide | 80.58 |
| 15 | Titanium oxide | 57.08 |
| 16 | Silicon oxide | 94.78 |
| 17 | Titanium oxide | 57.08 |
| 18 | Silicon oxide | 94.78 |
| 19 | Titanium oxide | 57.08 |
| 20 | Silicon oxide | 94.78 |
| 21 | Titanium oxide | 57.08 |
| 22 | Silicon oxide | 94.78 |
| 23 | Titanium oxide | 57.08 |
| 24 | Silicon oxide | 94.78 |
| 25 | Titanium oxide | 57.08 |
| 26 | Silicon oxide | 94.78 |
| 27 | Titanium oxide | 67.28 |
| 28 | Silicon oxide | 109.8 |
| 29 | Titanium oxide | 67.28 |
| 30 | Silicon oxide | 109.8 |
| 31 | Titanium oxide | 67.28 |
| 32 | Silicon oxide | 109.8 |
| 33 | Titanium oxide | 67.28 |
| 34 | Silicon oxide | 109.8 |
| 35 | Titanium oxide | 67.28 |
| 36 | Silicon oxide | 109.8 |
| 37 | Titanium oxide | 67.28 |
| 38 | Silicon oxide | 109.8 |
| 39 | Titanium oxide | 67.28 |
| 40 | Silicon oxide | 121.34 |
| 41 | Titanium oxide | 62.21 |
| 42 | Silicon oxide | 103.21 |
| 43 | Titanium oxide | 67.28 |
| 44 | Silicon oxide | 109.8 |
| 45 | Titanium | 9.29 |
| 46 | Silicon oxide | 179.04 |
| 47 | Titanium | 18.41 |
| Substrate | Copper | |

| | |
|---|---|
| Total thickness of layers | 3621.77 |

Variations to the reflector 102 depicted in FIG. 2 can be made while still being encompassed by embodiments of the invention. The reflector 102 may more generally be a device or material layer stack, and thus embodiments of the invention are not limited to a reflector. One or more of the layers 204, 206, and 208 may be absent from such a device or material layer stack. The multiple-layer optical dielectric 210 may more generally be a multiple-layer dielectric that does not have the optical properties of the dielectric 210. The number and composition of the layers 216 may vary as well. For instance, there may be less than two layers within each of the layers 216, or there may be more than two layers within each of the layers 216. Other variations and modifications can also be made while still being encompassed by embodiments of the invention.

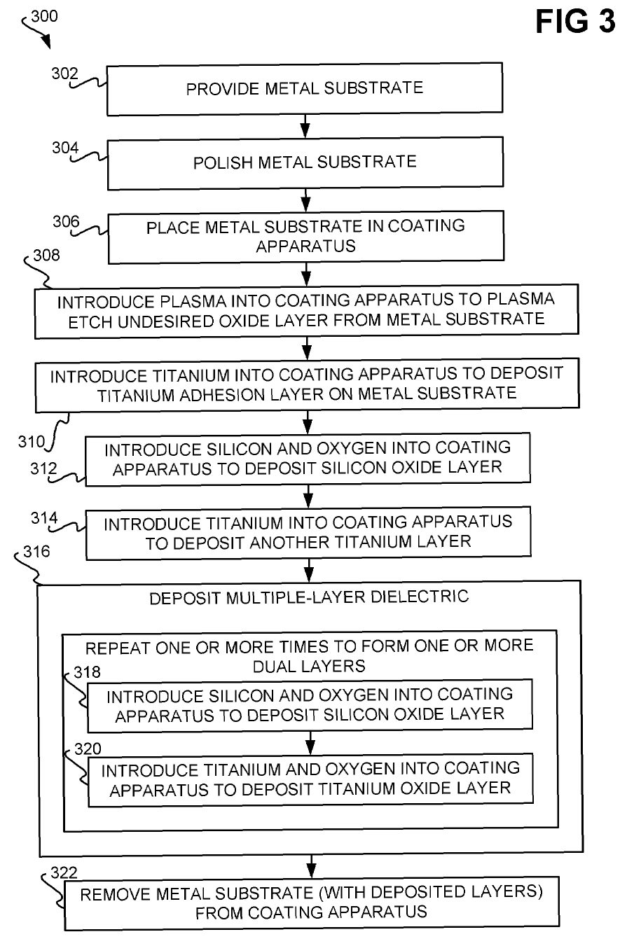

FIG. 3 shows a flowchart of a method 300 for at least partially fabricating the reflector 102, according to an embodiment of the invention. The method 300 may further be performed for other purposes, by not performing all parts of the method 300, and/or by varying performance of some of parts of the method 300, as can be appreciated by those of ordinary skill within the art. The metal substrate 202 of the reflector 102 is provided (302), which may be, for example, a copper or an aluminum substrate.

The metal substrate 202 is polished (304). Polishing the metal substrate 202 increases its reflectivity, and may be achieved by diamond turning, or another type of polishing process. During the polishing process, or otherwise, the metal substrate 202 is likely subjected to atmospheric exposure. The inherent oxygen within the atmosphere can result in growth of an undesired oxide layer to form on the metal substrate 202, which can reduce the reflectivity of the substrate 202, and can result in subsequent adhesion problems, as has been described.

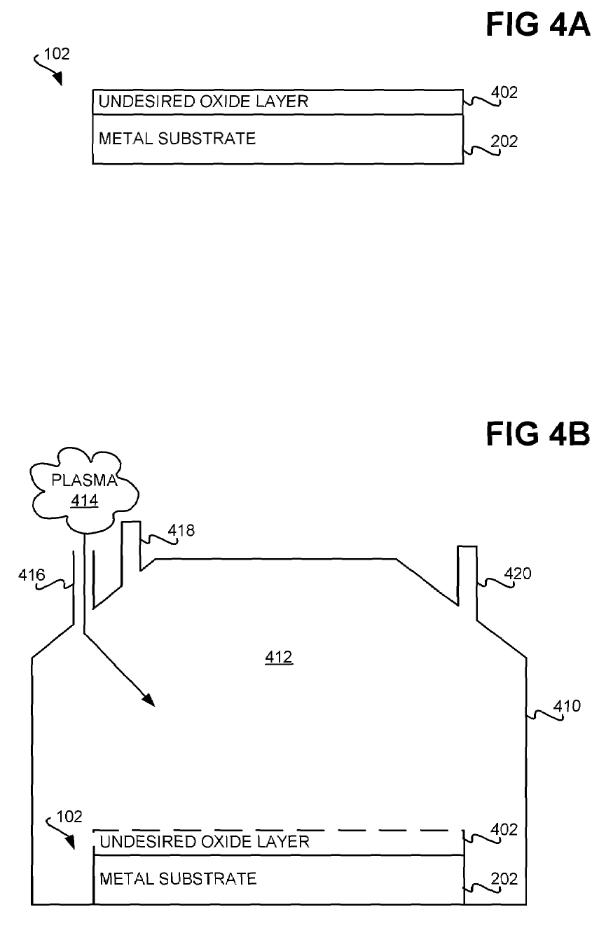

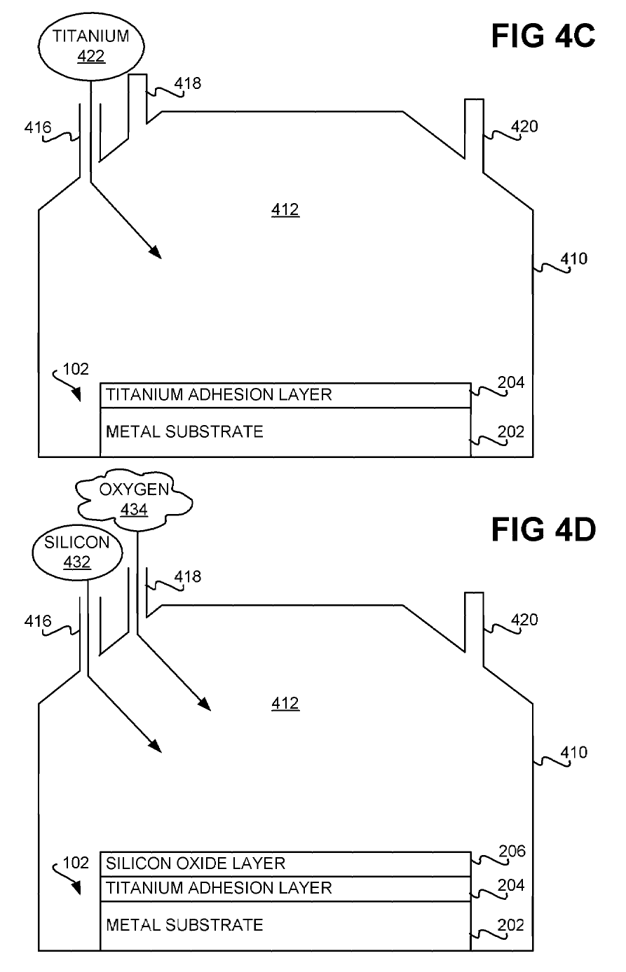

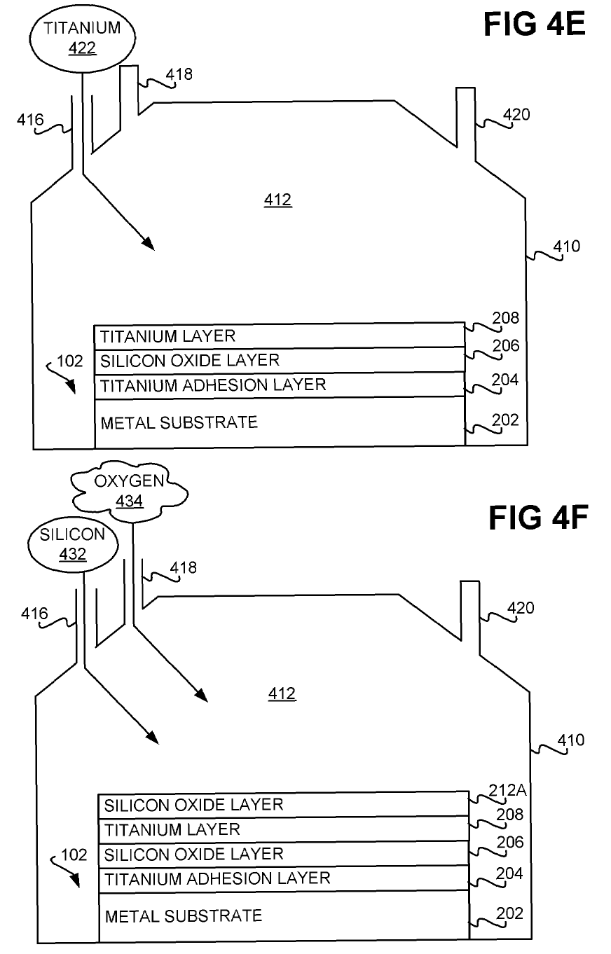

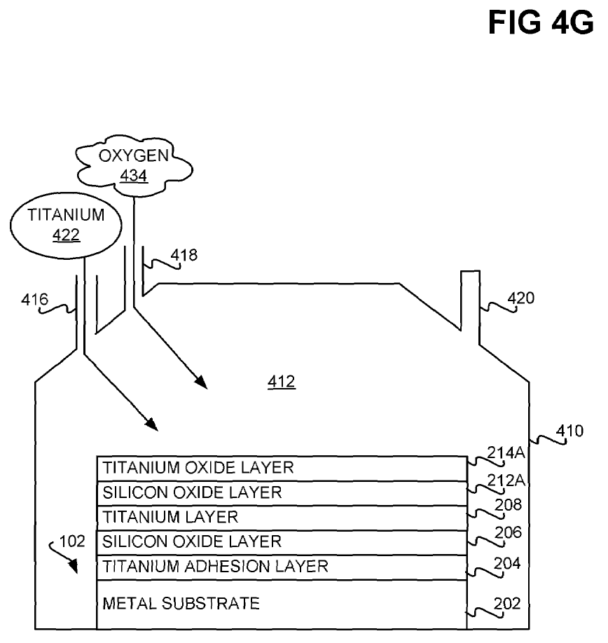

FIG. 4A shows illustrative performance of parts 302 and 304 of the method 300, according to an embodiment of the invention. The reflector 102 includes the metal substrate 202, which has had its top surface polished. An undesired oxide layer 402 has formed, or grown, on the metal substrate 202, due to exposure of the metal substrate 202 to oxygen within the atmosphere.

Referring back to FIG. 3, the metal substrate 202 is placed within a coating apparatus (306). The coating apparatus may be a conventional coating fabrication tool, also referred to as simply a coater, in which the metal substrate 202 is placed in a vacuum chamber of the apparatus. Examples of such a coating apparatus include a sputtering deposition tool, an evaporative deposition tool, and a chemical vapor deposition (CVD) tool. The apparatus is able to coat materials onto the metal substrate 202, by introducing the materials into the vacuum chamber, for instance.

First, however, plasma is introduced into the vacuum chamber of the coating apparatus to plasma etch the undesired oxide layer from the metal substrate 202 (308). Once the undesired oxide layer has been satisfactorily etched away by the plasma, the plasma is removed from the vacuum chamber. Thereafter, the metal substrate 202 remains within the coating apparatus at least until one or more desired layers have been deposited on the substrate 202. Otherwise, removing the metal substrate 202 from the vacuum chamber of the coating apparatus can result in again subjecting the substrate 202 to atmospheric exposure, and cause re-growth of the undesired oxide layer.

Therefore, one advantage of at least some embodiments of the invention is that removal of the undesired oxide layer from the metal substrate 202 occurs within the same coating apparatus that is also used to deposit desired layers onto the substrate 202. No special handling precautions have to be made after the undesired oxide layer has been removed from metal substrate 202, because the substrate 202 remains within the vacuum chamber of the coating apparatus until one or more desired layers have been deposited on the substrate 202. That is, if one tool were used for removal of the undesired oxide layer from the metal substrate 202, and another tool for deposition of the desired layers onto the substrate 202, special handling precautions would be required to ensure that the substrate 202 is not subjected to atmospheric exposure so that the undesired oxide layer does not re-grow.

FIG. 4B shows illustrative performance of parts 306 and 308 of the method 300, according to an embodiment of the invention. The metal substrate 202 has been placed within a vacuum chamber 412 of a representative coating apparatus 410. The coating apparatus 410 includes inlets 416 and 418, and an outlet 420. Other types of coating apparatuses, besides the coating apparatus 410, may be employed in relation to embodiments of the invention.

In FIG. 4B, the inlet 418 and the outlet 420 are closed. Plasma 414 is introduced into the open inlet 416, which results in plasma etching and thus removal of the undesired oxide layer 402, indicated in FIG. 4B by dotted lines to show that the layer 402 is being removed. Thereafter, the outlet 420 is open, to remove the plasma 414 and the oxide removed from the metal substrate 202 from the vacuum chamber 412. The metal substrate 202 remains within the vacuum chamber 412 of the coating apparatus 410, however.

Referring back to FIG. 3, titanium is next introduced into the coating apparatus to deposit the titanium adhesion layer 204 on the metal substrate 202 (310). Deposition may be achieved by sputtering, evaporative deposition, CVD, or by another process, depending on the actual coating apparatus employed. Once the desired thickness of the titanium adhesion layer 204 has been deposited, the remaining titanium is removed from the coating apparatus. It is noted that the titanium adhesion layer 204 is referred to as an adhesion layer due to one function of the layer 204 being to promote adhesion of the multiple-layer optical dielectric 210 to the metal substrate 202.

FIG. 4C shows illustrative performance of part 310 of the method 300, according to an embodiment of the invention. The metal substrate 202 has remained within the vacuum chamber 412 of the coating apparatus 410 since the removal of the undesired oxide layer 402 in part 308 of the method 300. The outlet 420 and the inlet 418 are or remain closed, while particles of titanium 422 are introduced in the open inlet 416 for deposition on the metal substrate 202 to realize the titanium adhesion layer 204. Once the desired thickness of the titanium adhesion layer 204 has been achieved, the outlet 420 is opened to remove any remaining titanium from the vacuum chamber 412 of the coating apparatus 410.

Referring back to FIG. 3, in one embodiment, silicon and oxygen are introduced into the coating apparatus to deposit the silicon oxide layer 206 on the metal substrate 202 (312). As before, deposition may be achieved by sputtering, evaporative deposition, CVD, or by another process, depending on the actual coating apparatus employed. Once the desired thickness of the silicon oxide layer 206 has been deposited, the remaining silicon and oxygen are removed from the coating apparatus.

FIG. 4D shows illustrative performance of part 312 of the method 300, according to an embodiment of the invention. The outlet 420 is closed, particles of silicon 432 are introduced in the open outlet 416, and oxygen 434 is introduced in the open outlet 418. The silicon 432 and the oxygen 434 react to form silicon oxide, which is deposited on the titanium adhesion layer 204 as the silicon oxide layer 206. Once the desired thickness of the silicon oxide layer 206 has been achieved, the outlet 420 is opened to remove any remaining silicon, oxygen, and silicon oxide from the vacuum chamber 412 of the coating apparatus 410.

Referring back to FIG. 3, in one embodiment, titanium is again introduced into the coating apparatus to deposit the other titanium layer 208 on the metal substrate 202 (314). As before, deposition may be achieved by sputtering, evaporative deposition, CVD, or by another process, depending on the actual coating apparatus employed. Once the desired thickness of the other titanium layer 208 has been deposited, the remaining titanium is removed from the coating apparatus.

FIG. 4E shows illustrative performance of part 314 of the method 300, according to an embodiment of the invention. The inlet 418 and the outlet 420 are closed, and particles of titanium 422 are introduced in the open outlet 416. The titanium is deposited on the silicon oxide layer 206 to realize the titanium layer 208. Once the desired thickness of the titanium layer 208 has been achieved, the outlet 420 is opened to remove any remaining titanium from the vacuum chamber 412 of the coating apparatus 410.

Referring back to FIG. 3, the multiple-layer optical dielectric 210, or another type of multiple-layer dielectric, is thereafter deposited on the metal substrate 202 (316). The multiple-layer optical dielectric 210 may have one or more one dual layers 216, which can be fabricated by repeating the following one or more times. Silicon and oxygen are introduced into the coating apparatus to deposit one of the silicon oxide layers 212 onto the metal substrate 202 (318), as has been described in relation to part 312 of the method 300.

FIG. 4F shows illustrative performance of part 318 of the method 300 in relation to the first silicon oxide layer 212A of the multiple-layer optical dielectric 210, according to an embodiment of the invention. The outlet 420 is closed, particles of silicon 432 are introduced in the open outlet 416, and oxygen 434 is introduced in the open outlet 418. The silicon 432 and the oxygen 434 react to form silicon oxide, which is deposited on the titanium layer 208 as the silicon oxide layer 212A. Once the desired thickness of the silicon oxide layer 212A has been achieved, the outlet 420 is opened to remove any remaining silicon, oxygen, and silicon oxide from the vacuum chamber 412 of the coating apparatus 410.

Titanium and oxygen are then introduced into the coating apparatus to deposit one of the titanium oxide layers 214 onto the metal substrate 202 (320). Deposition may be achieved by sputtering, evaporative deposition, CVD, or by another process, depending on the actual coating apparatus employed. Once the desired thickness of the titanium oxide layer in question has been deposited, the remaining titanium and oxygen are removed from the coating apparatus.

FIG. 4G shows illustrative performance of part 320 of the method 300 in relation to the first titanium oxide layer 214A of the multiple-layer optical dielectric 210, according to an embodiment of the invention. The outlet 420 is closed particles of titanium 422 are introduced in the open outlet 416, and oxygen 434 is introduced in the open outlet 418. The titanium 422 and the oxygen 434 react to form titanium oxide, which is deposited on the silicon oxide layer 212A as the titanium oxide layer 214A. Once the desired thickness of the titanium oxide layer 214A has been achieved, the outlet 420 is opened to remove any titanium silicon, oxygen, and silicon oxide from the vacuum chamber 412 of the coating apparatus 410.

Once the desired multiple-layer dielectric has been deposited on the metal substrate 202, the metal substrate 202 is removed from the coating apparatus (322). The method 300 that has been described is advantageous at least because it is a relatively simplified coating process. That is, just two “targets” besides oxygen are ever introduced into the coating apparatus to fabricate all the needed layers on the metal substrate 202. The titanium employed to fabricate the titanium oxide layers 214 is also used to fabricate the adhesion layer 204, as opposed to using a different type of material to fabricate the adhesion layer 204, which would result in additional cost and complexity, and may prevent some types of coating apparatuses, specifically “two target” coating apparatuses, from being employed. Therefore, in at least some embodiments of the invention, just titanium, silicon, and oxygen, in varying combinations, are ever introduced into the coating apparatus to deposit all needed layers on the metal substrate 202.

We claim:

1. A method comprising:
removing an oxidation layer from a metal substrate by plasma etching;
depositing a titanium adhesion layer on the metal substrate; and, depositing a multiple-layer dielectric on the titanium adhesion layer, the titanium adhesion layer improving adhesion of the multiple-layer dielectric to the metal substrate.

2. The method of claim 1, wherein depositing the multiple-layer dielectric on the metal substrate without first depositing the titanium adhesion layer on the metal substrate results in poor adhesion between the metal substrate and the multiple-layer dielectric.

3. The method of claim 1, further comprising initially polishing the metal substrate, such that atmospheric exposure of the metal substrate results in undesired growth of the oxidation layer on the metal substrate.

4. The method of claim 1, further comprising, after depositing the titanium adhesion layer and before depositing the multiple-layer dielectric:
depositing a silicon oxide layer on the titanium adhesion layer; and,
depositing another titanium layer on the metal substrate,
wherein the titanium adhesion layer and the other titanium layer are tuned to at least substantially absorb infrared energy to which the metal substrate is exposed through the multiple-layer dielectric, the multiple-layer dielectric being an optical dielectric to at least substantially transmit just visible light energy therethrough.

5. The method of claim 1, wherein removing the oxidation layer from the metal substrate comprises introducing plasma into a coating apparatus in which the metal substrate has been placed to plasma etch the oxidation layer from the metal substrate.

6. The method of claim 5, wherein depositing the titanium adhesion layer on the metal substrate comprises introducing titanium into the coating apparatus in which the metal substrate has been placed to deposit the titanium adhesion layer on the metal substrate,
wherein the metal substrate remains within the coating apparatus between removal of the oxidation layer and deposition of the titanium adhesion layer to prevent undesired re-growth of the oxidation layer prior to deposition of the titanium adhesion layer.

7. The method of claim 6, wherein depositing the multiple-layer dielectric on the titanium adhesion layer comprises repeating one or more times:
depositing a silicon oxide layer; and,
depositing a titanium oxide layer on the silicon oxide layer,
such that the multiple-layer dielectric comprises at least one or more dual silicon oxide-titanium oxide layers,
wherein the titanium oxide layers at least substantially absorb at least ultraviolet energy to which the metal substrate is exposed through the multiple-layer dielectric, the multiple-layer dielectric being an optical dielectric to at least substantially transmit just visible light energy therethrough.

8. The method of claim 7, wherein:
depositing the silicon oxide layer comprises introducing silicon and oxygen into the coating apparatus in which the metal substrate has been placed to deposit the silicon oxide layer, and
depositing the titanium oxide layer comprises introducing titanium and oxygen into the coating apparatus in which the metal substrate has been placed to deposit the titanium oxide layer,
wherein only titanium, silicon, and oxygen in varying combinations are ever introduced into the coating apparatus to deposit all needed layers on the metal substrate.

9. A method for at least partially fabricating a reflector for a projector lamp assembly, comprising:
providing a metal substrate of the reflector for the projector lamp assembly;
depositing a titanium adhesion layer on the metal substrate; and,
depositing a multiple-layer optical dielectric on the titanium adhesion layer, the multiple-layer optical dielectric tuned to at least substantially permit just visible light energy therethrough,
wherein the titanium adhesion layer improves adhesion of the multiple-layer optical dielectric to the metal substrate.

10. The method of claim 9, further comprising, prior to depositing the titanium adhesion layer on the metal substrate:
polishing the metal substrate, such that atmospheric exposure of the metal substrate results in undesired growth of an oxidation layer on the metal substrate; and,
removing the oxidation layer from the metal substrate by plasma etching.

11. The method of claim 9, further comprising, after depositing the titanium adhesion layer and before depositing the multiple-layer dielectric:
depositing a silicon oxide layer on the titanium adhesion layer; and,
depositing another titanium layer on the metal substrate,
wherein the titanium adhesion layer and the other titanium layer are tuned to at least substantially absorb infrared energy to which the metal substrate is exposed through the multiple-layer optical dielectric.

12. The method of claim 9, wherein depositing the titanium adhesion layer on the metal substrate comprises introducing titanium into a coating apparatus in which the metal substrate has been placed to deposit the titanium adhesion layer on the metal substrate.

13. The method of claim 12, wherein depositing the multiple-layer optical dielectric on the titanium adhesion layer comprises repeating one or more times:
depositing a silicon oxide layer by introducing silicon and oxygen into the coating apparatus in which the metal substrate has been placed; and,
depositing a titanium oxide layer on the silicon oxide layer by introducing titanium and oxygen into the coating apparatus in which the metal substrate has been placed,
such that the multiple-layer dielectric comprises at least one or more dual silicon oxide-titanium oxide layers,
wherein the titanium oxide layers at least substantially absorb at least ultraviolet energy to which the metal substrate is exposed through the multiple-layer optical dielectric, and
wherein only titanium, silicon, and oxygen in varying combinations are ever introduced into the coating apparatus to deposit all needed layers on the metal substrate.

14. A method comprising:
providing a metal substrate that has had undesired growth of an oxidation layer thereon;
placing the metal substrate within a coating apparatus such that the metal substrate remains protected from atmospheric exposure while in the coating apparatus;
removing the oxidation layer from the metal substrate by introducing plasma into the coating apparatus to plasma etch the oxidation layer from the metal substrate; and,
while the metal substrate remains within the coating apparatus, and before removing the metal substrate from the coating apparatus,
depositing one or more desired layers on the metal substrate by introducing different materials in different combinations.

15. The method of claim 14, wherein undesired growth of the oxidation layer on the metal substrate results at least from polishing the metal substrate while subjected to atmospheric exposure.

16. The method of claim 14, wherein depositing the desired layers on the metal substrate comprises depositing a titanium adhesion layer on the metal substrate by introducing titanium into the coating apparatus, the titanium adhesion layer improving adhesion of subsequently deposited layers to the metal substrate.

17. The method of claim 16, wherein depositing the desired layers on the metal substrate further comprises depositing a multiple-layer dielectric on the titanium adhesion layer by repeating one or more times:
depositing a silicon oxide layer by introducing silicon and oxygen into the coating apparatus; and,
depositing a titanium oxide layer on the silicon oxide layer by introducing titanium and oxygen into the coating apparatus,
such that the multiple-layer dielectric comprises at least one or more dual silicon oxide-titanium oxide layers,
wherein only titanium, silicon, and oxygen in varying combinations are ever introduced into the coating apparatus to deposit all the desired layers on the metal substrate.

18. A reflector for a projector lamp assembly, comprising:
a metal substrate;
a titanium adhesion layer on the metal substrate; and,
a multiple-layer optical dielectric on the titanium adhesion layer, the titanium adhesion layer improving adhesion of the multiple-layer optical dielectric to the metal substrate during usage of the projector lamp assembly.

19. The reflector of claim 18, further comprising:
a silicon oxide layer between the titanium adhesion layer and the multiple-layer optical dielectric; and,
another titanium layer, between the silicon oxide layer and the multiple-layer optical dielectric,
wherein the titanium adhesion layer and the other titanium layer are tuned to at least substantially absorb infrared energy to which the metal substrate is exposed through the multiple-layer optical dielectric.

20. The reflector of claim 18, wherein:
the metal substrate is one of copper and aluminum, and
the multiple-layer optical dielectric comprises:
one or more silicon oxide layers;
one or more titanium oxide layers interleaved in relation to the silicon oxide layers,
wherein the titanium oxide layers at least substantially absorb at least ultraviolet energy to which the metal substrate is exposed through the multiple-layer optical dielectric.
